(19) United States
(12) Patent Application Publication
(10) Pub. No.: US 2026/0252620 A1
(43) Pub. Date: Aug. 27, 2026

(54) LOGICAL WIDTH-BASED PROMPT CONDITIONING FOR GENERATIVE AI AND LLM

(71) Applicant: DISNEY ENTERPRISES, INC., Burbank, CA (US)

(72) Inventor: Anthony M. ACCARDO, Los Angeles, CA (US)

(21) Appl. No.: 19/062,221

(22) Filed: Feb. 25, 2025

(51) Int. Cl. G06F 16/36; G06F 16/383

(52) U.S. Cl. CPC G06F 16/367; G06F 16/383

(57) ABSTRACT

The present invention sets forth a technique for performing automated generation of descriptive metadata, the computer-implemented method comprising receiving one or more taxonomies associated with a media content ontology domain, a description of the one or more taxonomies, and one or more hierarchical relationships associated with the one or more taxonomies. The method also includes generating an ontology based on the one or more descriptions and the one or more hierarchical relationships and generating a prompt that includes a representation of the ontology, contextual information associated with a media content item, and a textual instruction to a machine learning model. The method further includes generating, via the machine learning model and based at least on the prompt, one or more descriptive metadata tags associated with the media content item.

### BACKGROUND

### Field of the Various Embodiments

Embodiments of the present disclosure relate generally to generative machine learning and, more specifically, to techniques for performing logical width-based prompt conditioning for generative machine learning models.

### Description of the Related Art

Generating descriptive metadata associated with a media content item is a common task in the field of machine learning. Media content items may include (but are not limited to) films, television or streaming episodes, podcasts, or other audiovisual content. Generated descriptive metadata may be used to organize media content items by classifying individual media content items into one or more categories based on characteristics associated with the media content item. The characteristics may include a genre associated with the media content item, a setting associated with the media content item, story elements included in the media content item, and/or characters or actors included in the media content item. Descriptive metadata may also serve as an input in a recommendation system that suggests one or more media content items to a consumer based on the descriptive metadata associated with the media content item.

Existing techniques for generating descriptive metadata may include manual annotation of a media content item by a human reviewer. These techniques may be time-consuming, as they may require that the human reviewer watch or listen to all or part of a media content item in real time, e.g., spending two hours watching a two-hour film. Consequently, these manual techniques may not be suitable for generating descriptive metadata associated with a large number of media content items, or for lengthy individual media content items. These manual techniques may also depend on the skill and/or experience of the human reviewer, making them error-prone and dependent on the subjective judgement of the individual reviewer.

Other existing techniques may include generating descriptive metadata using a pre-trained Large Language Model (LLM) or similar generative machine learning model. In these techniques, a pre-trained LLM or other machine learning model may be presented with a media content item and prompted to generate one or more particular items of descriptive metadata associated with the media content item. These techniques may depend on the innate capabilities of the pre-trained machine learning model, and may generate incorrect or inconsistent results, necessitating iterative re-prompting and re-generation to produce satisfactory results. In various generative machine learning techniques that also accept contextual information along with the media content item and prompt, the design of the generative machine learning model may limit both the quantity and type of contextual information that may be supplied as input. These limitations may also require iterative execution of the machine learning model, as well as a subjective determination by a human user of which contextual information to discard to satisfy the input limitations of the machine learning model. Repeatedly crafting input prompts and executing a machine learning model may result in excessive resource consumption, such as memory or processing cycles, and may increase the time required to obtain satisfactory results.

As the foregoing illustrates, what is needed in the art are more effective techniques for generating descriptive metadata associated with media content items.

### SUMMARY

One embodiment of the present invention sets forth a technique for performing automated generation of descriptive metadata. The technique includes receiving (i) one or more taxonomies associated with a media content ontology domain, (ii) a description of the one or more taxonomies, and (iii) one or more hierarchical relationships associated with the one or more taxonomies, and generating an ontology based on the one or more descriptions and the one or more hierarchical relationships. The technique also includes generating a prompt that includes (i) a representation of the ontology, (ii) contextual information associated with a media content item, and (iii) a textual instruction to a machine learning model, and generating, via the machine learning model and based at least on the prompt, one or more descriptive metadata tags associated with the media content item.

One technical advantage of the disclosed techniques relative to the prior art is that the disclosed techniques enable a user to generate a hierarchical ontology of taxonomies associated with a particular type of media content item. The disclosed techniques may provide the generated ontology to a generative machine learning model, along with contextual information, such as previously generated metadata for similar media content items. The disclosed techniques may also compress the generated ontology and associated contextual information prior to providing the ontology and associated contextual information to a generative machine learning model, maximizing the amount of information included in the machine learning model prompt. By maximizing the amount of contextual information subject to machine learning model input constraints, the disclosed techniques improve the quality of the generated metadata, while reducing both the necessary resources and the time required to generate descriptive metadata. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the ontology engine of FIG. 1, according to some embodiments.

FIG. 3 is a flow diagram of method steps for generating an ontology, according to some embodiments.

FIG. 4 is a more detailed illustration of the inference engine of FIG. 1, according to some embodiments.

FIG. 5 is a flow diagram of method steps for generating descriptive metadata associated with a media content item, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

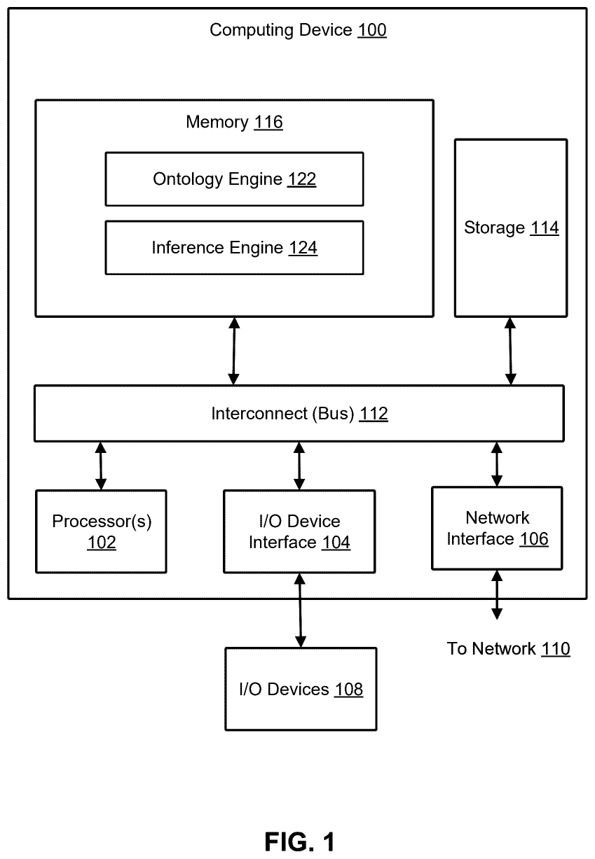

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an ontology engine 122 and an inference engine 124 that reside in a memory 116.

It is noted that the computing device described herein is illustrative and that any other technically feasible configurations fall within the scope of the present disclosure. For example, multiple instances of ontology engine 122 and/or inference engine 124 could execute on a set of nodes in a distributed and/or cloud computing system to implement the functionality of computing device 100. In another example, ontology engine 122 and/or inference engine 124 could execute on various sets of hardware, types of devices, or environments to adapt ontology engine 122 and/or inference engine 124 to different use cases or applications. In a third example, ontology engine 122 and/or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Ontology engine 122 and/or inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including ontology engine 122 and/or inference engine 124.

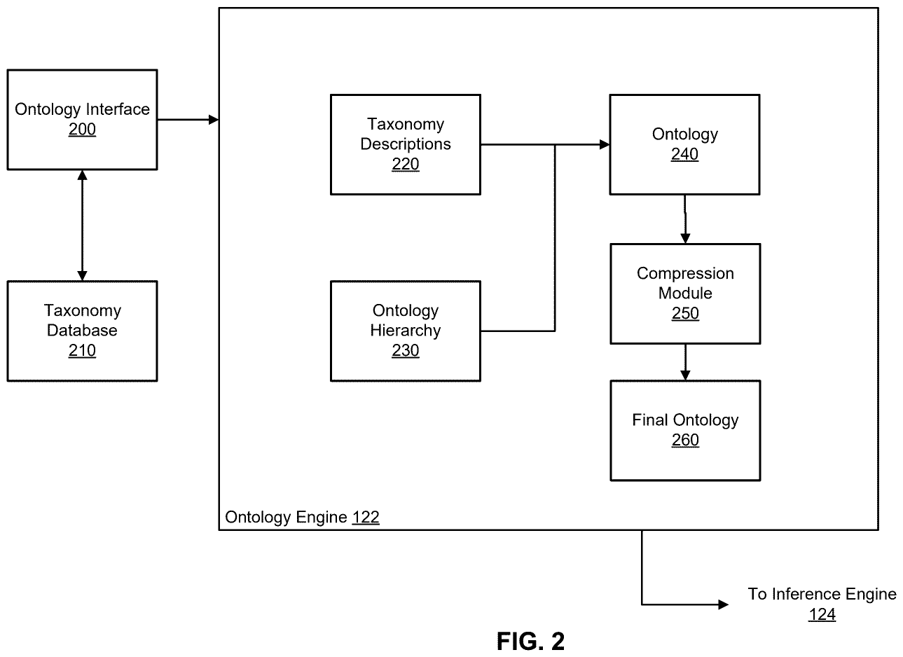

FIG. 2 is a more detailed illustration of ontology engine 122 of FIG. 1, according to some embodiments. Ontology engine 122 generates, via an ontology interface 200, a user-specified ontology, where the ontology includes a description of hierarchical relationships between one or more taxonomies. In various embodiments, the one or more taxonomies may be defined by a user or retrieved from taxonomy database 210. In various embodiments, ontology engine 122 may also compress the generated ontology. Ontology engine 122 may include, without limitation, taxonomy descriptions 220, ontology hierarchy 230, ontology 240, compression module 250, and final ontology 260.

Ontology interface 200 may include a device capable of both receiving input and providing output, such as one of I/O devices 108. In particular, ontology interface 200 may include a graphical and/or textual User Interface (UI). Via ontology interface 200, a user may specify one or more taxonomies associated with a specified ontology domain, as well as an ontology that includes hierarchical or other relationships between the one or more taxonomies. An ontology domain refers to a type of media content for which descriptive metadata is to be generated. Examples of ontology domains may include, for example, a film, a serialized television episode, a podcast, or a recording of a live audiovisual performance. In various embodiments, a taxonomy includes a concept associated with a particular ontology domain, such as a genre, setting, or story element associated with a film.

In various embodiments, a user may create a new top-level ontological object and specify an associated ontology domain and one or more associated taxonomies via ontology interface 200. For example, the user may specify a new top-level ontological object having an associated ontology domain of “standalone scripted video” for a feature-length film. The user may also specify a structure for the top-level ontological object. For example, the user may add the taxonomy “segment,” and define a “segment” as “any standardized segment of the scripted video into creatively holistic parts.” The user may then add an “act” as a type of segment and define an “act” as “the broadest segmentation of a scripted video. Generally, a single video has 3 acts, although variations exist. An act is a major creatively holistic component of a video that usually has a coherent purpose in advancing the story.” Similarly, the user may add a “scene” as an additional type of segment, and define a “scene” as “a logically coherent creative group of shots, generally contained within a single act of a video.” The user may further add a “shot” as an additional type of segment, where a scene comprises one or more shots.

The user may also add one or more physical element taxonomies to the top-level ontological object. For example, the user may specify a physical element taxonomy of “character,” and define a “character” as “a conscious agent that appears in the video directly or by reference.” The user may specify an additional physical element taxonomy “talent” and define “talent” as “a human who portrays a character or characters in a film”.

In addition to providing semantic descriptions for various taxonomies as discussed above, the user may also create explicit associations between different taxonomies. For example, given the “character” and “talent” taxonomies, the user may create an explicit association stating that “talent” portrays one or more “characters.”

In various embodiments, a user may provide a vocabulary including one or more examples and definitions for a taxonomy. For example, the user may add the taxonomy “agent” and define “agent” as “a set of types that define specifically how a character contributes to the establishment, advancement and resolution of a story.” The user may then provide examples that fall within the “agent” taxonomy, such as “doctor,” “wizard,” or “teacher,” along with definitions associated with each example agent.

In various embodiments, data types included in taxonomical terms or definitions may include text strings, numerical values, and/or dates. For example, a taxonomy may include a release date associated with a media content item, expressed in any suitable date format including one or more of a day, month, or year. Similarly, a taxonomy may describe a time period in which one or more portions of a media content item take place, and may include a single year, a range of years, and/or a textual description such as “Victorian Era” or “Postwar Europe.”.

A taxonomy may also include one or more calculations or comparisons. For example, a taxonomy specifying an “important character” may include references to one or more different taxonomies, such as specifying that a character associated with a “protagonist,” “antagonist,” or “mentor” taxonomy is also an “important character.” Alternatively or additionally, the “important character” taxonomy may include calculations that predict influential characters based on an analysis of one or more items of contextual content associated with a media content item. For example, the calculations may analyze the frequency and duration of a character's appearances in the media content item, based on a script and/or a synopsis associated with the media content item.

In various embodiments, ontology interface 200 may display a visual representation of the user-specified ontology, and update the visual representation as the user defines the structure of the ontology and adds taxonomies, descriptions, and/or explicit associations. The user may select a portion of the visual representation via, e.g., a mouse click, and add additional taxonomies, definitions, and/or explicit associations. The user may also select and modify previously entered elements of the ontology in a similar manner. Ontology interface 200 transmits the user-specified taxonomies and associated definitions to ontology engine 122 as taxonomy descriptions 220. Ontology interface 200 also transmits the hierarchical relationships included in the user-specified ontology to ontology engine 122 as ontology hierarchy 230.

In various embodiments, the user may additionally or alternatively select one or more predefined taxonomies, definitions, or explicit associations included in taxonomy database 210. Taxonomy database 210 may include various predefined taxonomies, definitions, and explicit associations relevant to multiple ontological domains. Ontology interface 200 may present one or items included in taxonomy database 210 to the user in response to a user action. For example, if the user has previously added the top-level ontological object “standalone scripted video” and subsequently interacts with ontology interface 200 to add a taxonomy to the top-level ontological object, ontology interface 200 may retrieve one or more taxonomies associated with the top-level ontological object and present the one or more taxonomies to the user for selection and/or modification. In another example, if the user has previously specified the taxonomies “character” and “talent” and wishes to define an explicit association for “talent,” ontology interface 200 may query taxonomy database 210, retrieve a predefined explicit association between the taxonomies “character” and “talent,” and present the predefined explicit association to the user for selection and/or modification.

Taxonomy descriptions 220 may include plain-language descriptions and/or definitions associated with one or more taxonomies specified by a user via ontology interface 200. As described above, the plain-language descriptions or definitions may include descriptions or definitions provided by the user, as well as descriptions or definitions included in taxonomy database 210 and selected by the user.

Ontology hierarchy 230 may include hierarchical or other relationships between taxonomies specified by the user via ontology interface 200. For example, a hierarchical relationship may include a part/whole relationship, such as a relationship stating that the taxonomy “act” includes one or more “scenes,” or that the taxonomy “scene” includes one or more “shots.” Other relationships may include user-specified explicit associations, such as an association stating that the taxonomy “talent” portrays one or more instances of the taxonomy “character.”

Ontology engine 122 processes taxonomy descriptions 220 and ontology hierarchy 230 to generate ontology 240. Ontology 240 may include one or more user-specified taxonomies, as well as user-specified descriptions or definitions associated with each of the one or more user-specified taxonomies. Ontology 240 may also include hierarchical or other relationships between ontologies, based on ontology hierarchy 230.

In various embodiments, ontology engine 122 may analyze ontology 240 and detect logical violations, missing relationships, and/or isolated concepts included in ontology 240. Ontology engine 122 may generate an alert, via ontology interface 200, informing the user as to the nature of the violation, missing relationship, or isolated concept and prompt the user to correct the detected violation, missing relationship, or isolated concept. For example, ontology engine 122 may generate an alert if ontology 240 includes relationships stating both that an “act” is comprised of one or more “scenes” and that a “scene” is comprised of one or more “acts.” Ontology engine 122 may also generate an alert if ontology 240 specifies an explicit association between taxonomies without including the necessary number of taxonomies to describe the explicit association. Ontology engine 122 may also generate an alert if ontology 240 includes a taxonomy with no associated definition or description that is also not referenced by any other taxonomy or explicit association included in ontology 240. Ontology engine 122 transmits ontology 240 to compression module 250.

In various embodiments, compression module 250 optionally reduces the size of one or more ontology elements included in ontology 240, such as taxonomy descriptions. Reducing the size of ontology elements may reduce the token count necessary when submitting a prompt including an ontology to a machine learning model, such as machine learning model 440 included in inference engine 124 discussed below.

Compression module 250 executes one or more symbolic logic techniques to replace portions of ontology 240 with symbolic equivalents containing fewer characters, thus reducing the overall size of ontology 240. For example, one or more symbolic logic techniques may replace one or more words and/or phrases with machine-readable symbols, such as machine-readable symbols representing the universal quantifier “for all,” the existential qualifier “there exists,” the conjunction “and,” or the disjunction “or.” Compression module 250 may also generate domain-specific symbols representing relationships included in ontology 240, such as “is portrayed by” or “appears in.” By replacing portions of ontology 240 with symbolic equivalents, ontology engine 122 may provide a greater amount of contextual information within the input constraints of a machine learning model, such as machine learning model 440 discussed below. Semantically compressing ontology 240 into a structured, symbolic logical format may also improve the subsequent reasoning performed by a machine learning model.

Portions of ontology 240 may include quantities of plain-language text, such as descriptions or definitions of taxonomies included in ontology 240. Compression module 250 may reduce the size of these plain-language portions via the removal of non-contextual labels such as articles and/or adverbs. In various embodiments, compression module 250 may also generate contractions, further reducing the size of the plain-language portions of ontology 240. In embodiments that include compression module 250, compression module 250 generates final ontology 260, and ontology engine 122 transmits final ontology 260 to inference engine 124.

In various embodiments, final ontology 260 includes the taxonomy descriptions and ontology hierarchy defined in ontology 240, compressed by compression module 250 as discussed above. In embodiments that do not include compression module 250, final ontology 260 may be identical to ontology 240.

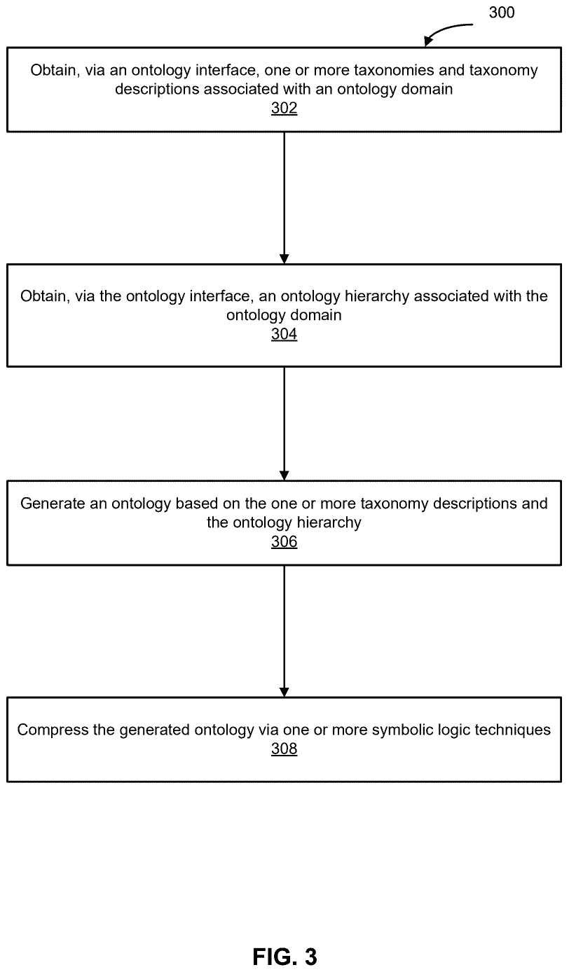

FIG. 3 is a flow diagram of method steps for generating an ontology, according to some embodiments. Although the method steps are described in conjunction with the systems of FIGS. 1 and 2, persons skilled in the art will understand that any system configured to perform the method steps in any order falls within the scope of the present disclosure.

As shown, in step 302 of method 300, ontology engine 122 obtains, via ontology interface 200, one or more taxonomies and taxonomy descriptions associated with an ontology domain. Examples of ontology domains may include, for example, a film, a serialized television episode, a podcast, or a recording of a live audiovisual performance. For example, the user may specify the taxonomy “character,” and define a “character” as “a conscious agent that appears in the video directly or by reference.” The user may specify an additional taxonomy “talent” and define “talent” as “a human who portrays a character or characters in a film”.

In step 304, ontology engine 122 obtains, via ontology interface 200, an ontology hierarchy associated with the ontology domain. For example, a hierarchical relationship may include a part/whole relationship, such as a relationship stating that the taxonomy “act” includes one or more “scenes,” or that the taxonomy “scene” includes one or more “shots.” Other relationships may include user-specified explicit associations, such as an association stating that the taxonomy “talent” portrays one or more instances of the taxonomy “character.”

In step 306, ontology engine 122 generates ontology 240 based on the one or more taxonomy descriptions and the ontology hierarchy. Ontology 240 may include one or more user-specified taxonomies, as well as user-specified descriptions or definitions associated with each of the one or more user-specified taxonomies. Ontology 240 may also include hierarchical or other relationships between ontologies, based on ontology hierarchy 230.

In various embodiments, ontology engine 122 may analyze ontology 240 and detect logical violations, missing relationships, and/or isolated concepts included in ontology 240. Ontology engine 122 may generate an alert, via ontology interface 200, informing the user as to the nature of the violation, missing relationship, or isolated concept and prompt the user to correct the detected violation, missing relationship, or isolated concept. For example, ontology engine 122 may generate an alert if ontology 240 includes relationships stating both that an “act” is comprised of one or more “scenes” and that a “scene” is comprised of one or more “acts.” Ontology engine 122 may also generate an alert if ontology 240 specifies an explicit association between taxonomies without including the necessary number of taxonomies to describe the explicit association. Ontology engine 122 may also generate an alert if ontology 240 includes a taxonomy with no associated definition or description that is also not referenced by any other taxonomy or explicit association included in ontology 240.

In step 308, ontology engine 122 may optionally compress ontology 240 via one or more symbolic logic techniques executed by compression module 250. Compression module 250 reduces the size of one or more ontology elements included in ontology 240, such as taxonomy descriptions. Reducing the size of ontology elements may reduce the token count necessary when submitting a prompt including an ontology to a machine learning model.

Compression module 250 executes one or more known symbolic logic techniques to replace portions of ontology 240 with symbolic equivalents containing fewer characters, thus reducing the overall size of ontology 240. For example, one or more symbolic logic techniques may replace one or more words and/or phrases with machine-readable symbols, such as machine-readable symbols representing the universal quantifier “for all,” the existential qualifier “there exists,” the conjunction “and,” or the disjunction “or.” Compression module 250 may also generate domain-specific symbols representing relationships included in ontology 240, such as “is portrayed by” or “appears in.”

Portions of ontology 240 may include quantities of plain-language text, such as descriptions or definitions of taxonomies included in ontology 240. Compression module 250 may reduce the size of these plain-language portions via the removal of non-contextual labels such as articles and/or adverbs. In various embodiments, compression module 250 may also generate contractions, further reducing the size of the plain-language portions of ontology 240. After optionally compressing ontology 240, ontology engine 122 transmits final ontology 260 to inference engine 124. In various embodiments that do not include or execute compression module 250, final ontology 260 may be substantially similar to ontology 240.

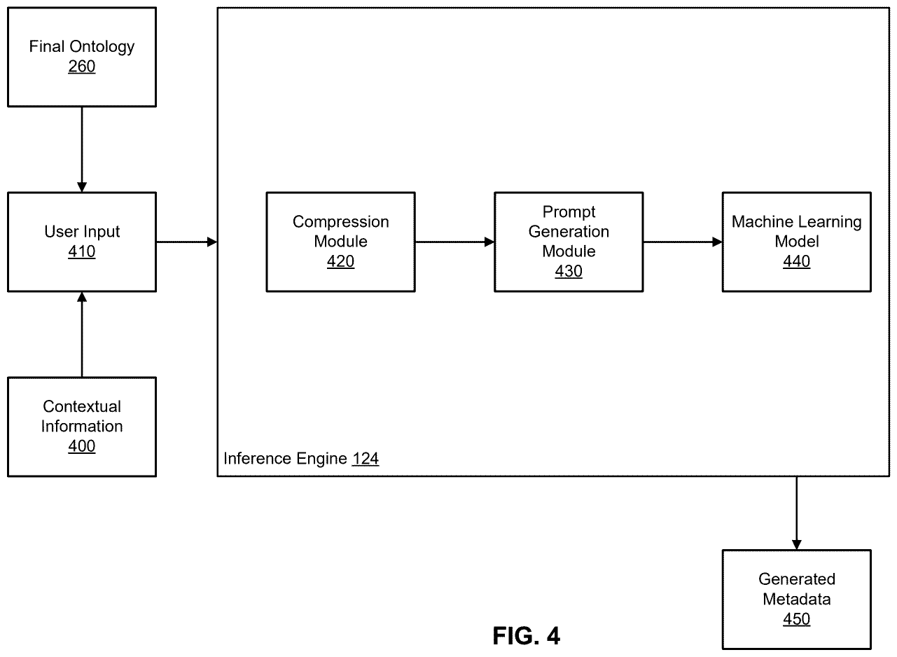

FIG. 4 is a more detailed illustration of inference engine 124 of FIG. 1, according to some embodiments. Inference engine 124 processes user input 410, final ontology 260, and contextual information 400, and produces generated metadata 450. Inference engine 124 may include, without limitation, compression module 420, prompt generation module 430, and machine learning model 440.

Inference engine 124 receives final ontology 260 from ontology engine 122. As discussed above in the description of FIG. 2, final ontology 260 includes one or more domain-specific taxonomies, and descriptions or definitions associated with each of the one or more domain-specific taxonomies. Final ontology 260 may also include hierarchical or other relationships between various taxonomies included in the one or more domain-specific taxonomies. For example, final ontology 260 may include the taxonomies “character” and “talent,” as well the explicit relationship that “talent” portrays one or more “characters.” Inference engine 124 makes final ontology 260 available to user input 410.

User input 410 may include a user-specified textual instruction to be submitted to a machine learning model, such as machine learning model 440 discussed below. For example, the user-specified textual instruction may state “Pretend you are a human metadata tagger who has learned the rules of the ontology submitted in this prompt, viewed the content and source materials, and tagged the example titles, resulting in the example metadata. New title “X” is now ready for tagging, and you will process the source materials and provide metadata tags that are compliant with the ontology and taxonomies.” The user may also include the ontology, associated taxonomies, and taxonomy descriptions included in final ontology 260, as well as contextual information 400. In various embodiments, the textual instruction to be submitted to the machine learning model may be prespecified, and/or obtained from a source other than user input 410. In other embodiments, the textual instruction may be received via user input 410 from a different user than the user who specified the ontology and/or taxonomies as discussed above in the description of FIG. 2.

Contextual information 400 may include previously generated example metadata associated with one or more example media content items. The previously generated example metadata may include one or more metadata tags associated with a taxonomy included in the ontology. For example, the previously generated example metadata may include metadata tags of “thriller” and “mystery” associated with the “genre” taxonomy included in the ontology. The previously generated example metadata may also include multiple instances of a taxonomy, where each instance may include a metadata tag. For instance, the previously generated example metadata may include multiple instances of the taxonomy “character,” where each instance of “character” is associated with metadata including the name of a character in the example media content item. The previously generated example metadata may also include multiple explicit associations between multiple instances of taxonomies, such as multiple instances of the taxonomy “talent,” where each instance of the taxonomy “talent” is explicitly associated with one or more instances of the taxonomy “character.”

For each of the one or more example media content items, contextual information 400 may also include associated source materials, such as one or more of a script, a synopsis, a closed-caption file, a theatrical trailer, or a published review. Inference engine 124 transmits user input 410, including the textual instruction, final ontology 260, and items of contextual information 400 to compression module 420.

Contextual information 400 may also include source materials associated with new title “X” for which inference engine 124 is to generate descriptive metadata. Similar to source materials associated with the one or more example media content items, source materials associated with a new title may include, but are not limited to, a script, a synopsis, a closed-caption file, a theatrical trailer, and/or a published review.

In various embodiments that include compression module 420, compression module 420 may optionally reduce the size of one or more portions of user input 410 via any suitable known symbolic logic techniques, such as the techniques discussed above in reference to compression module 250 of ontology engine 122. For example, compression module 420 may replace words and/or phrases in an item of source material included in contextual information 410, such as a synopsis, script, or closed-caption file, with machine-readable symbols requiring less data space than the replaced words and/or phrases. In embodiments where final ontology 260 has not previously been compressed, e.g., via compression module 250 of ontology engine 122, compression module 420 may also compress taxonomy descriptions and/or hierarchical or other relationships included in final ontology 260. Compression module 420 transmits user input 410 to prompt generation module 430.

Prompt generation module 430 analyzes user input 410, optionally compressed by compression module 420, and generates one or more machine learning prompts based on user input 410. Each of the one or more prompts may include a user-specified textual instruction, an ontology, previously generated example metadata associated with one or more example media content items, source materials associated with the one or more example media content items, and source materials associated with a new media content item to be tagged.

In various embodiments, prompt generation module 430 may segment optionally compressed user input 410, and generate the one or more machine learning prompts based on different orderings of segmented user input 410. Inference engine 124 may leverage the different orderings of segmented user input 410 to generate multiple different results from machine learning model 440 described below, based on the relative positions of the segments included in user input 410 with a generated machine learning prompt. For instance, machine learning model 440 may place more or less emphasis on segments included in user input 410 that are located at or near the beginning, middle, or end of a generated machine learning prompt.

For example, prompt generation module 430 may insert one or more delineators into user input 410, such as paragraph breaks, carriage returns, and/or pre-specified special characters or strings. The inserted delineators may separate the user-specified textual instruction, the ontology, the previously generated example metadata, the example source materials and/or the source materials associated with the new media content item into separate segments.

Prompt generation module 430 may generate the one or more machine learning prompts such that each machine learning prompt includes a different ordering of the segments included in user input 410. In various embodiments, each different ordering of the segments included in user input 410 may place a different segment at or substantially at the middle of the generated machine learning prompt. In other embodiments, each different segment ordering may place a different segment at or substantially at the beginning of the generated machine learning prompt. Prompt generation module 430 transmits the generated prompt(s) to machine learning model 440.

In various embodiments, machine learning model 440 may include a pre-trained machine learning model, such as a Large Language Model (LLM) or Multimodal Large Language Model (MLLM). In various embodiments, machine learning model 440 may also be fine-tuned using domain-specific training data. For example, machine learning model 440 may be repeatedly fine-tuned on training data including source materials and ground truth descriptive metadata tags associated with one or more training content items. Fine-tuning machine learning model 440 may improve its performance, as the fine-tuning provides additional example media content items and associated ground truth metadata without requiring that the training data fit within the input size constraints of a single input prompt.

Machine learning model 440 receives one or more machine learning prompts from prompt generation module 430 and produces generated metadata 450 based on the one or more machine learning prompts. As discussed above, the one or more machine learning prompts may collectively include a user-specified textual instruction, an ontology, previously generated example metadata associated with one or more example media content items, and/or contextual information associated with the one or more example media content items.

Generated metadata 450 includes descriptive metadata tags associated with one or more taxonomies included in final ontology 260 and provided to machine learning model 440 via prompt generation module 430. Generated metadata 450 may include multiple metadata tags associated with a single taxonomy. For example, generated metadata 450 may include the descriptive metadata tags “thriller” and “mystery” associated with the taxonomy “genre.” Generated metadata 450 may also include descriptive metadata tags associated with each of multiple instances of a taxonomy, such as multiple instances of the taxonomies “character” or “talent.” Generated metadata 450 may further include explicit associations between metadata tags associated with different taxonomies, such as an association between an actor's name included in a metadata tag associated with a “talent” taxonomy and a character name associated with a “character” taxonomy. In various embodiments, generated metadata 450 may also include, for each descriptive metadata tag, references to one or more source materials associated with the newly tagged media content item upon which machine learning model 440 based its inferences when generating the metadata tag.

Inference engine 124 may display one or more items included in generated metadata 450 via, e.g., one or more of I/O devices 108. Inference engine 124 may also store generated metadata 450 in, e.g., storage 114 for later retrieval, display, or processing. In various embodiments, inference engine 124 may accept user feedback associated with generated metadata 450. For each item of metadata included in generated metadata 450, associated user feedback may include a confirmation that the metadata item is correct, or an indication that the metadata item is incorrect. When a user indicates that a metadata item is incorrect, the user may supply one or more correct values associated with the metadata item, and/or specify one or more source materials supporting the correct value(s). Inference engine 124 may associate the user feedback with generated metadata 450 and store the user feedback and/or the one or more source materials with generated metadata 450 in, e.g., storage 114.

In various embodiments where prompt generation module 430 generates multiple different machine learning prompts based on different orderings of user input 410 as described above, inference engine 124 may present multiple instances of generated metadata 450, based on one or more of the multiple different machine learning prompts, to the user. The user may identify one of the multiple instances of generated metadata 450 as correct, or may identify one or more portions of generated metadata 450 from one or more of the multiple instances as correct. Inference engine 124 may assemble the user-identified portions included in the multiple instances of generated metadata 450 into a final instance of generated metadata 450.

Inference engine 124 may fine-tune machine learning model 440 based on previously generated metadata, associated user feedback, and/or source materials associated with the user feedback. In various embodiments, inference engine 124 may fine-tune machine learning model 440 immediately upon receipt of user feedback, at specified time intervals, after receipt of a specified quantity of user feedback, and/or upon explicit direction from a user.

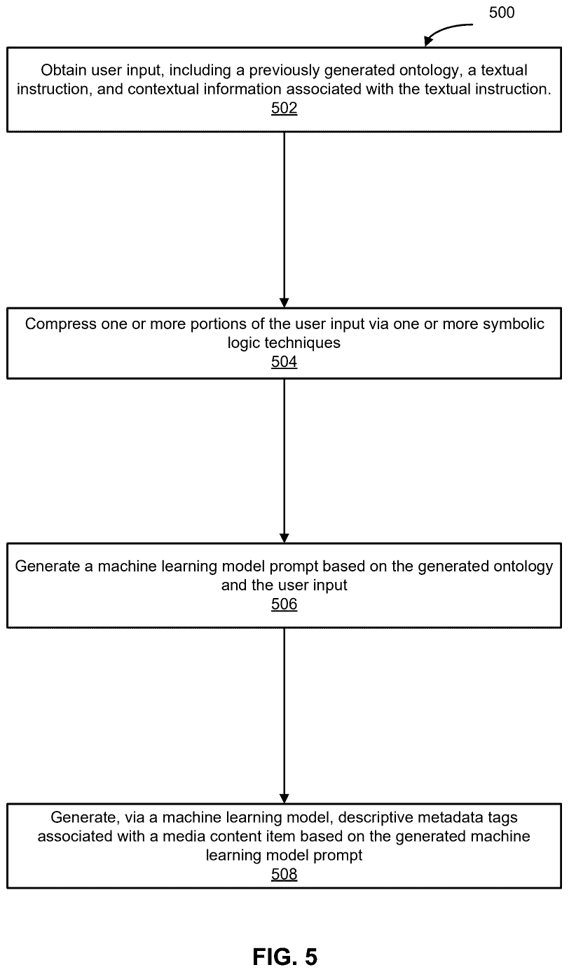

FIG. 5 is a flow diagram of method steps for generating descriptive metadata for a media content item, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, inference engine 124 obtains user input 410, including final ontology 260, a textual instruction, and contextual information 400 associated with the textual instruction. As discussed above in the description of FIG. 2, final ontology 260 may include a top-level description of a domain associated with the ontology, such as “standalone scripted video.” Final ontology 260 may also include one or more taxonomies, and definitions, descriptions, and/or examples associated with the one or more taxonomies. The textual instruction may direct machine learning model 440 to analyze contextual information associated with a new media content item and generate descriptive metadata associated with one or more of the taxonomies included in the ontology. Contextual information 400 may include source materials associated with one or more example media content items, such as synopses, scripts, closed-caption files, or critical reviews. Contextual information 400 may also include descriptive metadata tags for one or more taxonomies included in the ontology, where the descriptive metadata is based at least on the source materials. In various embodiments, the textual instruction to be submitted to the machine learning model may be prespecified, and/or obtained from a source other than user input 410. In other embodiments, the textual instruction may be received via user input 410 from a different user than the user who specified the ontology and included taxonomies.

In step 504, compression module 420 may optionally compress one or more portions of user input 410, such as taxonomy definitions and/or source materials associated with the one or mor example media content items. Compression module 420 may reduce the size of one or more portions of user input 410 via any suitable known symbolic logic techniques, such as the techniques discussed above in reference to compression module 250 of ontology engine 122. For example, compression module 420 may replace words and/or phrases in an item of source material included in contextual information 410, such as a synopsis, script, or closed-caption file, with machine-readable symbols requiring less data space than the replaced words and/or phrases. In embodiments where final ontology 260 has not previously been compressed, e.g., via compression module 250 of ontology engine 122, compression module 420 may also compress taxonomy descriptions and/or hierarchical or other relationships included in final ontology 260. Compression module 420 transmits user input 410 to prompt generation module 430.

In step 506, prompt generation module 430 analyzes final ontology 260 and user input 410, and produces one or more machine learning prompts based on final ontology 260 and user input 410. Each of the one or more prompts may include a user-specified textual instruction, an ontology, previously generated descriptive metadata tags associated with one or more example media content items, source material associated with the one or more example media content items, and source materials associated with a new media content item for which descriptive metadata is to be generated. Prompt generation module 430 transmits the generated prompt(s) to machine learning model 440.

In step 508, machine learning model 440 generates descriptive metadata tags associated with a new media content item based on the generated machine learning model prompt(s). In various embodiments, machine learning model 440 may include a pre-trained machine learning model, such as a Large Language Model (LLM) or Multimodal Large Language Model (MLLM). In various embodiments, machine learning model 440 may also be fine-tuned using domain-specific training data. Machine learning model 440 receives one or more machine learning prompts from prompt generation module 430 and produces generated metadata 450 based on the one or more machine learning prompts. As discussed above, the one or more machine learning prompts may collectively include a user-specified textual instruction, an ontology, previously generated example metadata tags associated with one or more example media content items source materials associated with the one or more example media content items, and source materials associated with the new media content item.

Generated metadata 450 includes descriptive metadata tags for the new media content item and associated with one or more taxonomies included in final ontology 260. Generated metadata 450 may include multiple metadata tags associated with a single taxonomy. For example, generated metadata 450 may include the descriptive metadata tags “thriller” and “mystery” associated with the taxonomy “genre.” Generated metadata 450 may also include descriptive metadata tags associated with each of multiple instances of a taxonomy, such as multiple instances of the taxonomies “character” or “talent.” Generated metadata 450 may further include explicit associations between metadata tags associated with different taxonomies, such as an association between an actor's name included in a metadata tag associated with a “talent” taxonomy and a character name included in a metadata tag associated with a “character” taxonomy. Inference engine 124 may display one or more items included in generated metadata 450 via, e.g., one or more of I/O devices 108. Inference engine 124 may also store generated metadata 450 in, e.g., storage 114 for later retrieval, display, or processing. Generated metadata 450 may inform or enable one or more subsequent tasks, such as grouping or otherwise classifying media content items, searching for media content items, recommending media content items to a user or group of users, and/or performing statistical or other analyses on media content items.

In sum, the disclosed techniques perform automated generation of descriptive metadata associated with a media content item. The descriptive metadata includes values associated with one or more taxonomies, where a taxonomy includes a concept, such as a genre, setting, or story element associated with a particular domain, such as a film or TV episode. The disclosed techniques allow a user to interactively define an ontology that describes hierarchical or other relationships between various taxonomies in a specific domain. For example, an ontology that describes hierarchical relationships in a film may specify that a film includes one or more acts, and that each act includes one or more scenes. The ontology may further specify that a scene includes one or more shots. The user may also provide or select a plain-language definition or description for each taxonomy included in an ontology, such as definitions or descriptions for an act, a scene, and/or a shot. The user may provide a representation of the defined ontology to a pre-trained machine learning model, along with ground truth descriptive metadata tags associated with each of the one or more sample media content items. The user may also provide contextual information associated with each of the one or more sample media content items, such as a synopsis of the media content item, a script associated with the sample media content item, or a closed-captioning file associated with the sample media content item. The user may also provide contextual information associated with a media content item for which descriptive metadata is to be generated by the pre-trained machine learning model. The pre-trained machine learning model generates descriptive metadata tags for the media content item, based on the ontology, the contextual information associated with the sample media content items, ground truth descriptive metadata associated with the sample media content items, and the contextual information associated with the media content item for which descriptive metadata is to be generated.

The disclosed techniques may compress one or more of the inputs to the pre-trained machine learning model, removing redundant, unnecessary, or vague textual information in one or more of the ontology, contextual information associated with sample media content items, and/or contextual information associated with the media content item for which the pre-trained machine learning model is to generate descriptive metadata. Compressing the inputs to the pre-trained machine learning model allows the disclosed techniques to provide as much useful information as possible to the pre-trained machine learning model, subject to any input size constraints associated with the pre-trained machine learning model.

In operation, an ontology engine allows a user to generate, via an ontology interface, an ontology associated with a particular media content item. The ontology interface may also allow the user to retrieve and optionally modify a previously generated ontology. The user may specify one or more taxonomies to be included in the ontology, either through descriptive input or via selection from a populated list of available taxonomies. For example, when generating an ontology associated with a film, the user may specify one or more film-related, domain-specific taxonomies, such as “act,” “scene,” shot,” “genre,” “setting,” “story elements,” “character,” or “talent.” The user may also select or describe hierarchical or other relationships between the different taxonomies. For example, the user may specify that the taxonomy “talent” refers to an actor who portrays one or more “characters” in a film, or that the taxonomy “act” includes one or more “scenes,” where a “scene” includes one or more “shots.” The ontology engine then transmits the generated ontology to an inference engine.

The ontology engine may compress the generated ontology via symbolic logic techniques to reduce the size of the ontology when subsequently presented as input to a machine learning model, such as a Large Language Model (LLM) or Multi-modal Large Language Model (MLLM). For example, the compression techniques may convert a plain-language description of a relationship between two taxonomies included in the ontology into a symbolic representation of the relationship. Similarly, the compression techniques may strip out redundant, unnecessary, or vague language from plain-language elements of the taxonomy, such as adverbs or articles. The compression techniques may also simply replace words with shorter corresponding representations.

The inference engine receives the generated ontology from the ontology engine, along with contextual information associated with the ontology. The contextual information may include descriptive metadata tags corresponding to one or more example media content items, where the tagged descriptive metadata serves as an example output for the inference engine. The contextual information may also include, for each of the one or more example media content items, a synopsis of the example media content item, a script of the example media content item, a closed-captioning file associated with the example media content item, or published review(s) of the example media content item. The inference engine may include a multi-modal machine learning model that is operable to accept contextual information including audiovisual content associated with the example media content item. Such audiovisual content may include a film trailer, a podcast discussing the example media content item, an Edit Decision List (EDL) associated with the example media content item, or still images or video sequences taken from the example media content item.

The inference engine also receives contextual information associated with a new media content item for which the inference engine is to generate descriptive metadata. The contextual information associated with the new media content item may include one or more of the same types of contextual information as provided for the one or more example media content items. In a similar manner as the ontology engine, the inference engine may compress the contextual information associated with the one or more example media content items, as well as the contextual information associated with the new media item.

The inference engine generates a prompt for a pre-trained machine learning model, such as an LLM or a MLLM. The prompt includes the generated ontology, the tagged descriptive metadata associated with the example media content item(s), the contextual information associated with the example media content item(s), and the contextual information associated with the new media content item for which the machine learning model is to generate descriptive metadata. As an example, the prompt may include instructive text, such as “Pretend you are a human metadata tagger who has learned the rules of the ontology submitted in this prompt, has viewed the content and contextual information, and tagged the example media content items, resulting in the example descriptive metadata. A new media content item “X” is now ready for tagging, and you will process the associated contextual information and provide tags that are compliant with the ontology and taxonomies.”

Based on the submitted prompt, the machine learning model generates, for each taxonomy included in the generated ontology, one or more items of descriptive metadata. For example, given an ontology including at least the taxonomies “genre,” “setting,” “character,” and “talent,” the machine learning model may generate the descriptive metadata “western,” and associate the metadata with the taxonomy “genre.” Similarly, the machine learning model may generate the metadata “19^{th} century American West” associated with the taxonomy “setting,” and further generate metadata describing that “Billy the Kid” is a “character” included in the media content item, portrayed by “talent” “John Q. Actor.” After generating descriptive metadata for one or more taxonomies included in the ontology, the inference engine may visually display the ontology and associated descriptive metadata. Additionally or alternatively, the inference engine may store one or more of the ontology, the associated generated descriptive metadata, and/or the contextual information associated with the new media content item for later retrieval or transmission to a downstream software component.

One technical advantage of the disclosed techniques relative to the prior art is that the disclosed techniques enable a user to generate a hierarchical ontology of taxonomies associated with a particular type of media content item. The disclosed techniques may provide the generated ontology to a generative machine learning model, along with contextual information, such as previously generated metadata for similar media content items. The disclosed techniques may also compress the generated ontology and associated contextual information prior to providing the ontology and associated contextual information to a generative machine learning model, maximizing the amount of information included in the machine learning model prompt. By maximizing the amount of contextual information subject to machine learning model input constraints, the disclosed techniques improve the quality of the generated metadata, while reducing both the necessary resources and the time required to generate descriptive metadata. These technical advantages provide one or more improvements over prior art approaches.
1. In some embodiments, a computer-implemented method for performing automated generation of descriptive metadata, the computer-implemented method comprises receiving (i) one or more taxonomies associated with a media content ontology domain, (ii) a description of the one or more taxonomies, and (iii) one or more hierarchical relationships associated with the one or more taxonomies, generating an ontology based on the one or more descriptions and the one or more hierarchical relationships, generating a prompt that includes (i) a representation of the ontology, (ii) contextual information associated with a media content item, and (iii) a textual instruction to a machine learning model, and generating, via the machine learning model and based at least on the prompt, one or more descriptive metadata tags associated with the media content item.
2. The computer-implemented method of clause 1, wherein generating the prompt comprises compressing, via one or more symbolic logic techniques, one or more of the ontology, the description of the one or more taxonomies, or the hierarchical relationships.
3. The computer-implemented method of clauses 1 or 2, wherein the machine learning model includes a pre-trained generative machine learning model.
4. The computer-implemented method of any of clauses 1-3, wherein the prompt further includes example descriptive metadata tags associated with one or more example media content items and contextual information associated with the one or more example media content items.
5. The computer-implemented method of any of clauses 1-4, wherein the media content ontology domain includes at least one of a film, a serialized television episode, a podcast, or a recording of a live audiovisual performance.
6. The computer-implemented method of any of clauses 1-5, wherein the media content ontology domain includes a film, and the one or more taxonomies include a genre, setting, or story element.
7. The computer-implemented method of any of clauses 1-6, wherein the contextual information includes one or more of a script, a synopsis, a closed-caption file, a theatrical trailer, or a published review.
8. The computer-implemented method of any of clauses 1-7, wherein each of the one or more descriptive metadata tags includes a value associated with one of the one or more taxonomies or a value associated with one of the one or more hierarchical relationships.
9. The computer-implemented method of any of clauses 1-8, further comprising fine-tuning the machine learning model using training data including at least one of ontologies, source materials, or ground truth descriptive metadata tags associated with one or more training content items.
10. The computer-implemented method of any of clauses 1-9, wherein the machine learning model includes a multimodal machine learning model operable to accept two or more of still images, text, audio recordings, or video sequences as input.
11. In some embodiments, one or more non-transitory computer-readable media store instructions that, when executed by one or more processors, cause the one or more processors to perform the steps of receiving (i) one or more taxonomies associated with a media content ontology domain, (ii) a description of the one or more taxonomies, and (iii) one or more hierarchical relationships associated with the one or more taxonomies, generating an ontology based on the one or more descriptions and the one or more hierarchical relationships, generating a prompt that includes (i) a representation of the ontology, (ii) contextual information associated with a media content item, and (iii) a textual instruction to a machine learning model, and generating, via the machine learning model and based at least on the prompt, one or more descriptive metadata tags associated with the media content item.
12. The one or more non-transitory computer-readable media of clause 11, wherein generating the prompt comprises compressing, via one or more symbolic logic techniques, one or more of the ontology, the description of the one or more taxonomies, or the hierarchical relationships.
13. The one or more non-transitory computer-readable media of clauses 11 or 12, wherein the machine learning model includes a pre-trained generative machine learning model.
14. The one or more non-transitory computer-readable media of any of clauses 11-13, wherein the prompt further includes example descriptive metadata tags associated with one or more example media content items and contextual information associated with the one or more example media content items.
15. The one or more non-transitory computer-readable media of any of clauses 11-14, wherein the media content ontology domain includes a film, a serialized television episode, a podcast, or a recording of a live audiovisual performance.
16. The one or more non-transitory computer-readable media of any of clauses 11-15, wherein the media content ontology domain includes a film, and the one or more taxonomies include a genre, setting, or story element.
17. The one or more non-transitory computer-readable media of any of clauses 11-16, wherein the contextual information includes one or more of a script, a synopsis, a closed-caption file, a theatrical trailer, or a published review.
18. The one or more non-transitory computer-readable media of any of clauses 11-17, wherein each of the one or more descriptive metadata tags includes a value associated with one of the one or more taxonomies or a value associated with one of the one or more hierarchical relationships.
19. In some embodiments, a system comprises one or more memories storing instructions, and one or more processors for executing the instructions to receive (i) one or more taxonomies associated with a media content ontology domain, (ii) a description of the one or more taxonomies, and (iii) one or more hierarchical relationships associated with the one or more taxonomies, generate an ontology based on the one or more descriptions and the one or more hierarchical relationships, generate a prompt that includes (i) a representation of the ontology, (ii) contextual information associated with a media content item, and (iii) a textual instruction to a machine learning model, and generate, via the machine learning model and based at least on the prompt, one or more descriptive metadata tags associated with the media content item.
20. The system of clause 19, wherein the prompt further includes example descriptive metadata tags associated with one or more example media content items and contextual information associated with the one or more example media content items.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing automated generation of descriptive metadata, the computer-implemented method comprising:
receiving (i) one or more taxonomies associated with a media content ontology domain, (ii) a description of the one or more taxonomies, and (iii) one or more hierarchical relationships associated with the one or more taxonomies;
generating an ontology based on the one or more descriptions and the one or more hierarchical relationships;
generating a prompt that includes (i) a representation of the ontology, (ii) contextual information associated with a media content item, and (iii) a textual instruction to a machine learning model; and
generating, via the machine learning model and based at least on the prompt, one or more descriptive metadata tags associated with the media content item.

2. The computer-implemented method of claim 1, wherein generating the prompt comprises compressing, via one or more symbolic logic techniques, one or more of the ontology, the description of the one or more taxonomies, or the hierarchical relationships.

3. The computer-implemented method of claim 1, wherein the machine learning model includes a pre-trained generative machine learning model.

4. The computer-implemented method of claim 1, wherein the prompt further includes example descriptive metadata tags associated with one or more example media content items and contextual information associated with the one or more example media content items.

5. The computer-implemented method of claim 1, wherein the media content ontology domain includes at least one of a film, a serialized television episode, a podcast, or a recording of a live audiovisual performance.

6. The computer-implemented method of claim 1, wherein the media content ontology domain includes a film, and the one or more taxonomies include a genre, setting, or story element.

7. The computer-implemented method of claim 1, wherein the contextual information includes one or more of a script, a synopsis, a closed-caption file, a theatrical trailer, or a published review.

8. The computer-implemented method of claim 1, wherein each of the one or more descriptive metadata tags includes a value associated with one of the one or more taxonomies or a value associated with one of the one or more hierarchical relationships.

9. The computer-implemented method of claim 1, further comprising fine-tuning the machine learning model using training data including at least one of ontologies, source materials, or ground truth descriptive metadata tags associated with one or more training content items.

10. The computer-implemented method of claim 1, wherein the machine learning model includes a multimodal machine learning model operable to accept two or more of still images, text, audio recordings, or video sequences as input.

11. One or more non-transitory computer-readable media storing instructions that, when executed by one or more processors, cause the one or more processors to perform the steps of:
receiving (i) one or more taxonomies associated with a media content ontology domain, (ii) a description of the one or more taxonomies, and (iii) one or more hierarchical relationships associated with the one or more taxonomies;
generating an ontology based on the one or more descriptions and the one or more hierarchical relationships;
generating a prompt that includes (i) a representation of the ontology, (ii) contextual information associated with a media content item, and (iii) a textual instruction to a machine learning model; and
generating, via the machine learning model and based at least on the prompt, one or more descriptive metadata tags associated with the media content item.

12. The one or more non-transitory computer-readable media of claim 11, wherein generating the prompt comprises compressing, via one or more symbolic logic techniques, one or more of the ontology, the description of the one or more taxonomies, or the hierarchical relationships.

13. The one or more non-transitory computer-readable media of claim 11, wherein the machine learning model includes a pre-trained generative machine learning model.

14. The one or more non-transitory computer-readable media of claim 11, wherein the prompt further includes example descriptive metadata tags associated with one or more example media content items and contextual information associated with the one or more example media content items.

15. The one or more non-transitory computer-readable media of claim 11, wherein the media content ontology domain includes a film, a serialized television episode, a podcast, or a recording of a live audiovisual performance.

16. The one or more non-transitory computer-readable media of claim 11, wherein the media content ontology domain includes a film, and the one or more taxonomies include a genre, setting, or story element.

17. The one or more non-transitory computer-readable media of claim 11, wherein the contextual information includes one or more of a script, a synopsis, a closed-caption file, a theatrical trailer, or a published review.

18. The one or more non-transitory computer-readable media of claim 11, wherein each of the one or more descriptive metadata tags includes a value associated with one of the one or more taxonomies or a value associated with one of the one or more hierarchical relationships.

19. A system comprising:
one or more memories storing instructions; and
one or more processors for executing the instructions to:
receive (i) one or more taxonomies associated with a media content ontology domain, (ii) a description of the one or more taxonomies, and (iii) one or more hierarchical relationships associated with the one or more taxonomies;
generate an ontology based on the one or more descriptions and the one or more hierarchical relationships;
generate a prompt that includes (i) a representation of the ontology, (ii) contextual information associated with a media content item, and (iii) a textual instruction to a machine learning model; and
generate, via the machine learning model and based at least on the prompt, one or more descriptive metadata tags associated with the media content item.

20. The system of claim 19, wherein the prompt further includes example descriptive metadata tags associated with one or more example media content items and contextual information associated with the one or more example media content items.
